(19) United States
(12) Patent Application Publication
(10) Pub. No.: US 2021/0209672 A1
(43) Pub. Date: Jul. 8, 2021

(54) FRAUD REDUCTION SYSTEM

(71) Applicant: Quix supply Inc., Newport Beach, CA (US)

(72) Inventors: Gregory A. Barela, Irvine, CA (US); Richard A. Armstrong, Costa Mesa, CA (US); John Cronin, Williston, VT (US); Joseph Bodkin, Williston, VT (US)

(21) Appl. No.: 16/995,580

(22) Filed: Aug. 17, 2020

Related U.S. Application Data
(63) Continuation-in-part of application No. 16/721,573, filed on Dec. 19, 2019, now abandoned.
(60) Provisional application No. 62/782,269, filed on Dec. 19, 2018.

(51) Int. Cl. G06Q 30/06; G06Q 10/08

(52) U.S. Cl. CPC G06Q 30/0637; G06Q 10/0833; G06Q 10/087

(57) ABSTRACT

The present disclosure is directed to methods and apparatus for fulfilling orders within a local community. Methods and apparatus consistent with the present disclosure may receive communications from user devices, may provide inventory information to those user devices, may accept orders for products from user devices, may require that a supervisor approve an order before that order can be processed, and may allow for users to arrange for the delivery of ordered products within minutes or hours after an order has been placed. In certain instances, user devices may be identified as being associated with a customer account based on customer identifiers. Method and apparatus consistent with the present disclosure may also receive customer profile information that is used to process and pay for orders.

### CROSS-REFERENCE TO RELATED APPLICATION

This application is a continuation-in-part of U.S. patent application Ser. No. 16/721,573 filed Dec. 19, 2019, which claims priority from U.S. provisional patent application 62/782,269 filed Dec. 19, 2018, which are incorporated by reference herein in their entirety.

### FIELD OF THE DISCLOSURE

The present disclosure is generally related to preventing fraud. More specifically the present disclosure is directed to receiving, validating, and fulfilling orders for products within a region.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Often when parts, materials, or supplies are required at a construction site, an employee is tasked with driving to a store and purchasing the required parts, materials, or supplies using their own cash or credit cards. The employee, may then have to collect receipts and provided these receipts to their employer, such that these employees can be reimbursed for the purchase. This process relies on trust as part of an honor system. Employees, however may cheat and purchase additional items that they keep for themselves. This may occur in instances when a particular receipt does not include a list of the products purchased. Alternatively this may occur even when a receipt does include an itemized list. For example, an employee may purchase 10 pieces of a particular part and only deliver 9 of those pieces to his worksite. This may also occur instances when an employer does not carefully review a receipt. What are needed are systems and methods that allow a supervisor to more easily review items purchased by an employee.

### SUMMARY OF THE PRESENTLY CLAIMED INVENTION

The presently claimed invention relates to a method, a non-transitory computer-readable storage medium, or an apparatus that performs functions consistent with the present disclosure. A method consistent with the present disclosure may receive registration information that identifies a first business name, payment information, a first worksite location, and a supervisor device. Methods consistent with the present disclosure may also include extracting order information that identifies a first product from a received order, identifying that the order for the first product is associated with the registration information, and sending an order validation request message to the supervisor device. After the validation request message is sent to the supervisor device, a response to that validation request message may be received. Information included in this response message may identify that the order for the first product has been authorized and the order for the first product may be fulfilled after the order for the first product has been authorized.

When the presently claimed method is implemented as a non-transitory computer readable storage medium, a processor executing instructions out of the memory may implement a method consistent with the present disclosure. Here again, the method may include receiving registration information that identifies a first business name, payment information, a first worksite location, and a supervisor device. The processor executing instructions out of the memory may also extract order information that identifies a first product from a received order, identify that the order for the first product is associated with the registration information, and send an order validation request message to the supervisor device. After the validation request message is sent to the supervisor device, a response to that validation request message may be received. Information included in this response message may identify that the order for the first product has been authorized and the order for the first product may be fulfilled after the order for the first product has been authorized.

An apparatus consistent with the present disclosure may include a memory, a processor, and a communication interface. The execution of instructions out of the memory by the processor may cause the processor to store received registration information that identifies a first business name, payment information, a first worksite location, and a supervisor device. The processor may also execute instructions out of the memory to extract order information that identifies a first product from a received order. The processor may then identify that the order for the first product is associated with the registration information and prepare an order validation request message to be sent to the supervisor device, after which the validation request message may be sent to the supervisor device. After the request message is sent to the supervisor device, a response to the validation request message may be received via the communication interface. This response may include information that identifies that the order for the first product has been authorized and the order for the first product may be fulfilled after the order for the first product has been authorized.

### BRIEF DESCRIPTIONS OF THE DRAWINGS

FIG. 1 illustrates a number of computing devices that may be used to prevent fraud by tracking product purchase information.

FIG. 2 illustrates a series of steps that may be performed when user orders are received by a computer that processes customer orders.

FIG. 3 illustrates a set of steps that may be performed when a customer order is received.

FIG. 4 illustrates a series of steps that may be performed at a user device when a customer orders products.

FIG. 5 illustrates another series of steps that may be performed at an ordering computer that receives product queries and that arranges for the fulfillment of product orders.

FIG. 6 illustrates a series of steps that may be performed by a device that receives delivery data and that provides delivery status information to other computing devices.

FIG. 7 illustrates a computing system that may be used to implement an embodiment of the present invention.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

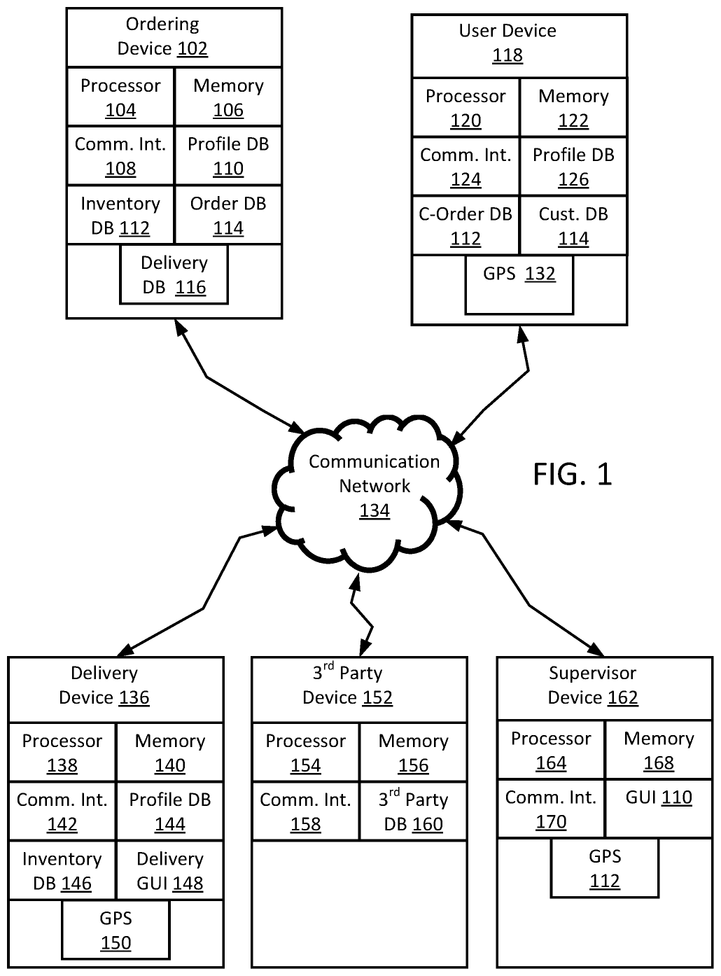

FIG. 1 illustrates a number of computing devices that may be used to prevent fraud by tracking product purchase information. FIG. 1 includes ordering platform device 102, user device platform 118, delivery device 136, third (3^{rd}) party platform 152, and supervisor device 162 that may send and receive communications over communication network 134. Ordering platform device 102 includes processor 104, memory 106, communication interface 108, profile database 110, inventory database 112, order database 114, and delivery database 116. Processor 104 may execute instructions out of memory 106 when orders are made and when the fulfillment of orders are tracked over time. The instructions executed by processor 104 may include instructions associated with one or more software modules that perform base functions associated with processing customer orders, these base functions may check inventories of products that may be purchased from one or more vendors. Apparatus consistent with the present disclosure may track ordering and/or the delivery of products. As such, memory 106 may store instructions associated with a base software module, an inventory software module, an order software management module, and a software delivery module. In certain instances, each of the databases 110, 112, 114, and 116 may include one or more persistent data storage devices at ordering platform device 102. Once ordering platform device 102 receives an order, data relating to that order may be sent to supervisor device 162 such that the order can be reviewed and authorized by a worksite supervisor.

Profile database 110 may store information that identifies customer information. Inventory database 112 may store product inventory data that has been received from one or more third party computing devices. Order database 114 may store information regarding orders that have been placed by various different customers. Delivery database 116 may store information regarding locations where products are or have been delivered to or may store information relating to the status of a delivery.

User device platform 118 may be a computing device of any sort known in the art. As such, user device 118 may be a desktop computer, a notebook computer, a tablet computing device, or a cell phone. User device 118 includes processor 120, memory 122, communication interface 124, user profile database 126, customer order database 128, a display that may display customer graphical user interface (GUI) 130, and a global positioning system (GPS) 132. The different databases 126 & 128 included in user device 118 may be comprised of one or more persistent data storage devices at user device 118. User profile database 126 may store information that identifies the customer and customer order database 128 may store information relating to products ordered from user device 118. Processor 120 may execute instructions out of memory 122 when performing base functions consistent with one or more software modules that allow customers to order products from vendors after receiving product selections via customer GUI 130. For example, a first software module could perform functions consistent with providing user profile data to ordering platform device 102 or to 3^{rd} party platform 152. Instructions consistent with a customer order software module may be executed when a customer orders products for pick up or delivery. In certain instances, data collected from GPS system 132 at user device 118 may be used to identify a location where ordered products should be delivered. Alternatively, a customer may provide a delivery address via customer GUI 130.

Supervisor device 162 includes processor 164, memory 168, communication interface 170, graphical user interface (GUI) 110, and global positioning system 112. After ordering device 102 receives an order for materials, information that identifies items that are being ordered may be sent via communication interface 108 at ordering device 102, communication network 134, and communication interface 170 at supervisor device 162. After the ordering information is received at supervisor device 162, the received ordering data may be displayed in GUI 110 of supervisor device 162. At this time a supervisor may review the order data to verify that correct materials and correct material quantities are included in the order. For example, a supervisor may identify that a the order includes a quantity of ten 2″×4″ boards that are ten feet long, 100 pounds of sand, one thousand square feet of floor boards, and ten gallons of white paint. After the supervisor checks the order, he may authorize that order by making a selection in GUI 112 and messages may be sent from supervisor device to other devices indicating that the order has been authorized. After the order has been authorized, the order may be fulfilled. When the order arrives at a worksite, the supervisor may once again validate that all of the ordered materials have been received and the supervisor may make another selection in GUI 112 that validates that the ordered products were correctly delivered to the worksite. Processor 164 may execute instructions out of memory 168 at supervisor device 162 when these validations are performed. Validation information sent from supervisor device via communication interface 170 may include location information collected by GPS system 112 at supervisor device 162. In this way, a GPS location included in validation data may be used to demonstrate that supervisor device was really located at the worksite when a validation is performed. In this way, even the actions of a supervisor may be reviewed by auditing personnel. This could allow the auditing personnel to identify fraud committed by a supervisor. For example, auditing personnel could check delivery data and identify that the supervisor device was not located at the worksite location when the ordered materials were delivered. Such anomalous information at least indicates that a person operating user device 162 was in a location where that person could actually validate that the order was correctly received. Supervisor device 162 may also receive a selection via GUI 110 that indicates that the order should be declined. In such an instance, supervising device 162 may send messages to other devices that results in the order being cancelled.

Delivery device 136 includes processor 138, memory 140, communication interface 142, product database 144, delivery database 146, a display that displays delivery GUI 148, and GPS system 150. The different databases included in user device 118 may include of one or more persistent data storage devices at user device 118. Databases 144 and 146 may be stored in memory 140 or may be stored in one or more persistent data storage devices at delivery device 136. Information stored in product database 144 may include information that identifies products that are being delivered or that have been delivered by delivery personnel and delivery database 146 may store information relating to customers that ordered products and locations where those products should be delivered to. GPS system 150 may provide information that can be sent to other computing devices that identifies a current location of delivery device 136 when products are being transported from a vendor to a customer location. Processor 138 may execute instructions out of memory 140 when products are delivered to a destination. Delivery device 136 may only receive order information after supervisor device 162 has sent a message authorizing that are order be fulfilled. Delivery device 162 may also receive a confirmation message sent from supervisor device 162. In certain instances, validation messages may be sent from supervisor device 162 to ordering device 102 and ordering device 102 may forward that message to delivery device 162. Alternatively or additionally, delivery device 136 and supervisor device 162 may exchange communications using a short distance communication technology such as Bluetooth or near field communications. Software at supervisor device 162 may include one or more software modules that perform that allow processor 162 to implement functions consistent with the present disclosure. In certain instances, approval module software at supervisor device 162 may be a software program application (e.g. an APP) that may be downloaded and installed on supervisor device 162 from an online store such as the Apple APP store.

Third party platform 152 includes processor 154, memory 156, communication interface 158, and 3^{rd} party database 160. Processor 154 may execute instructions out of memory 156 when products are ordered by customers. Products sold by a 3^{rd} party vendor may be stored in the 3^{rd} party database 160, such that customers may review and order those products. Data stored in 3^{rd} party database 160 may include pricing and availability information that may be sent to other computing devices over communication interface 158 and communication network 134. Processor 154 may execute instructions out of memory 156 when products are offered for sale to customers and when product orders are fulfilled.

In operation ordering platform device 102 may allow customers to search through inventory of connected 3^{rd} party vendors 152 for materials and supplies, place orders at the 3^{rd} party vendors 152, allow payment for the materials and supplies, provide a delivery service in which a person picks up the ordered materials and supplies and delivers them to a jobsite. Processor 104 at ordering platform device 102 may receive data from user device 118 via communication interfaces 124 and 108 and communication network 134. The data received from user device 118 may include user profile data and order data that may be respectively stored in profile database 110 and order database 114. User device 118 may also provide payment information to ordering platform device 102 when payments for orders are processed. User device 118 may also receive product inventory data sent from ordering platform device 102 based on user requests. This inventory data may have been retrieved from inventory database 112 and may be provided to user device 118 via communication interface 108, communication network 134, and communication interface 124.

After receiving data from user device 118, communications may be sent from ordering platform device 102 to 3^{rd} party platform 152. These communications may retrieve inventory data stored in 3^{rd} party database 160 after which this inventory data may be provided to user device 118. This inventory data may also be stored in inventory database 112 at ordering platform device 102. In certain instances, ordering platform device may pull inventory data from 3^{rd} party platform periodically. Alternatively or additionally, ordering platform device may pull data from 3^{rd} party platform 152 that is identified in a user profile stored in profile database 110 at ordering platform device 102. The storing of this inventory data in inventory database 116 may allow user device 118 to review inventory at various 3^{rd} party vendors that may be selected for purchase from those 3^{rd} party vendors.

Instructions executable by processor 104 at ordering platform device 102 may allow a customer to select products that they wish to purchase and may allow payment information to be received from user device 118. At this time, a customer may make selections in GUI 130 that may identify this payment information and that may also identify delivery information. When a customer orders products to be delivered to a location, data may be sent to delivery device 136. This delivery data may be sent from ordering platform device 102 directly to delivery device 136 via communication interface 108, communication network 134, and communication interface 142. Persons that deliver products to customers may be employees or contractors of ordering platform device 102. Alternatively these delivery persons may be employees of contractors of a 3^{rd} party vendor.

Ordering platform device 102 may collect and store the customer inventory selections received from user device 118 and this information may be stored in order database 114. The customer order database 128 at user device 118 may be accessed when payments are processed. Once products are ordered, delivery device 136 may be sent the store location, job site delivery location (e.g. address or GPS location), materials ordered, payment information, and driving directions. After delivery device 136 receives the customer order and store location information from ordering platform device 102, ordered products may be picked up and delivered by a person that has access to the delivery device. Ordering platform device 102 may also store customer order information, payment options, a GPS location of a selected 3^{rd} party vendor 152, and a GPS location of the jobsite in order database 114.

User device 118 may be any computing device known in the art such as a laptop computer, a smartphone, tablet computer, or a smart speaker. Base software at user device 118 may allow user device 118 to connect to the ordering platform device 102. User device 118 may allow a customer to input options via GUI 132. For example, a user may enter payment options, user profile data, and may initiate operations at ordering platform device 102. User profile database 126 may store customer payment information and other customer information. Instructions included in a user device customer order software module at user device 118 may allow the user device 118 to connect to the ordering platform device 108 when products are ordered. User device GUI 132 may allow users to select products and those selected products may be stored in customer order database 128 after which orders for those selected products may be sent to ordering platform device 102.

The customer order database 128 at user device 118 may store information that identifies items or products selected by the user. The customer GUI 130 or another user interface may either accept inputs from users or provide outputs to users or may perform both these actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Furthermore, the interface(s) may either be implemented as a command line interface (CLI), a graphical user interface (GUI), a voice interface, or a web-based user-interface. User device GPS 132 may be used to identify the location of the user device 118. Delivery device 140 may be any type of computing device known in the art, such as a laptop computer, a smartphone, tablet computer, or smart speaker. Software at delivery device 136 may include a delivery device delivery product software module that includes instructions for receiving and delivering customer orders. Information received by delivery device 136 may identify payment options, store pickup locations, and jobsite locations. This information may be received from the ordering platform device 102. Delivery product database 146 may store the information received from ordering platform device 102. Delivery GUI 148 or other user interface(s) at delivery device 136 may either accept inputs from users or provide outputs to the users, or may perform both of these actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a command line interface (CLI), a graphical user interface (GUI), a voice interface, or a web-based user-interface. The delivery device GPS 150 may be used to determine the location of the delivery device. The 3^{rd} party database 160 at 3^{rd} party platform 152 may store information regarding materials and supplies sold by that 3^{rd} party vendor. Exemplary 3^{rd} party vendors include Home Depot, Lowes, and Ace Hardware. Software at 3^{rd} Party platform may include a 3^{rd} party software module that may include instructions that allows communications to be received from ordering platform device 102 such that ordering platform device 102 may receive inventory data and reserve products that are in stock at a particular 3^{rd} party vendor.

Communication network 134 may be any form of network known in the art. When communication network is a wireless network, communications may be passed using communication techniques such as visible light communication (VLC), Worldwide interoperability for microwave access (WiMAX), long term evolution (LTE), wireless local area network (WLAN), infrared (IR) communication, public switched telephone network (PSTN), radio waves, cellular, and other communication techniques known in the art. Communication network 134 may allow ubiquitous access to shared pools of configurable system resources and higher-level services that can be rapidly provisioned with minimal management effort, where communications may be transmitted over the Internet. Methods consistent with the present disclosure may rely on sharing of resources to achieve coherence and economies of scale, like a public utility, while third-party clouds may enable organizations to focus on their core businesses instead of expending resources on computer infrastructure and maintenance.

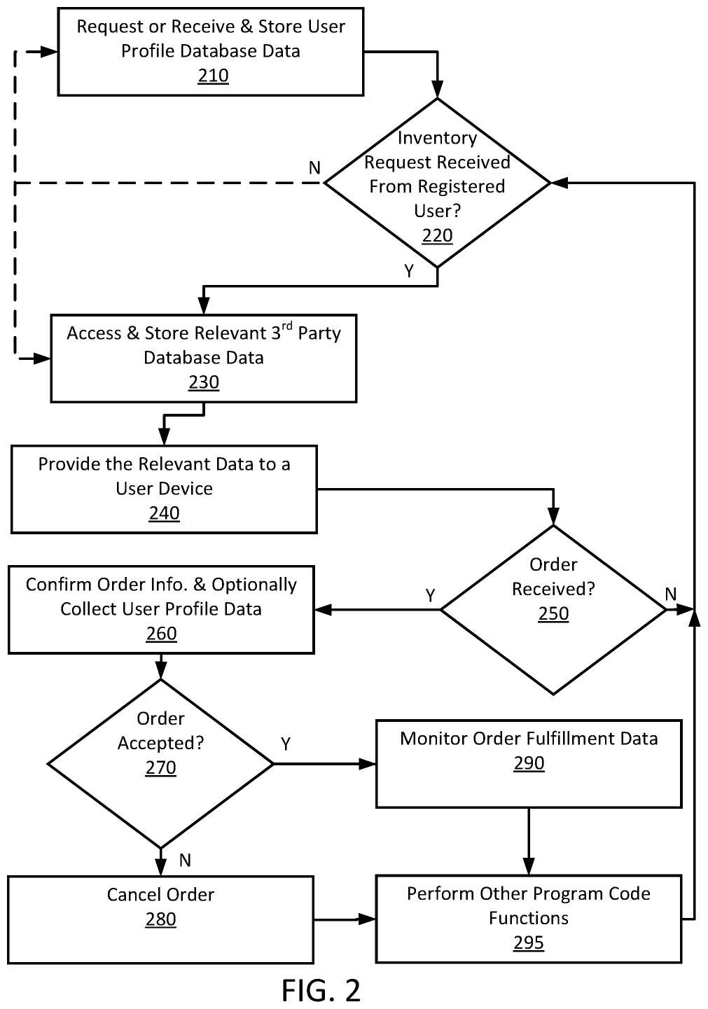

FIG. 2 illustrates a series of steps that may be performed when user orders are received by a computer that processes customer orders. Operations performed in FIG. 2 may include functions consistent with one or more sets of software modules, such as the aforementioned base software module, inventory software module, or order software management module at an ordering computer, such as ordering platform device 102 of FIG. 2. FIG. 2 begins with step 210 where user profile data may be received and stored in a database. This profile data may identify customer information, delivery information, or other information. Table 1 includes an exemplary set of data that may be stored in a profile data base at a computer that processes customer orders, such as ordering platform device 102 of FIG. 1. Table 1 cross-references a customer identifier (ID) with other customer information that includes a person's name, a company name, a business address/zip/state, credit card information, dates when a respective credit card expires, and a jobsite location. For example, table 1 identifies that customer ID TD1234 is associated with an account of Tom Jackson, a company named Jackson Contractors that is located on 123 Main Street in Los Angeles Calif., and with a zip code of 90005. Customer ID TJ1234 also is associated with credit card 1234-4567-8912-3456 that expires in April 2020. Table 1 also identifies that customer Id TJ1234 is also associated with jobsite location 45 Sunset Avenue, Los Angeles, Calif., 90005. The data stored in the profile database of table 1 may be used to identify a customer, identify payment information, and identify locations where ordered products should be delivered. When the data of table 1 is stored in a database located at an ordering computer, a user device that orders products may not have to provide order and delivery information to the ordering computer each time an order is received. Instead, after an initial registration process all that a user device need provide is a customer ID when products are ordered.

TABLE 1
Profile Database Data

| | | | Business | | | | |
|---|---|---|---|---|---|---|---|
| Customer | | Company | Address & | | Credit Card | Expire | Jobsite |
| ID | Name | Name | Zip | State | Information | Date | Location |
| TJ1234 | Tom | Jackson | 123 | CA | 1234-4567- | April | 45 Sunset |
| | Jackson | Contractors | Main | | 8912-3456 | 2020 | Avenue, Los |
| | | | Street, | | | | Angeles, CA, |
| | | | Los | | | | 90005 |
| | | | Angeles | | | | |
| | | | 90005 | | | | |
| BM0987 | Bob | Bob and | 45 Elm | CA | 9876-5432- | May | 1 Ocean |
| | Meyers | Sons | Street, | | 2198-7654 | 2020 | Street, Los |
| | | | Los | | | | Angeles, CA |
| | | | Angeles | | | | 90001 |
| | | | 90001 | | | | |
| SM6543 | Sam | Michel | 76 | CA | 6543-2198- | September | 98 3rd |
| | Michel | Construction | 2nd | | 4561-3214 | 2022 | Avenue, Los |
| | | | Avenue, | | | | Angeles, CA, |
| | | | Los | | | | 90009 |
| | | | Angeles | | | | |
| | | | 90009 | | | | |
| DL2345 | Dan | Lewis Local | 56 Oak | CA | 4569-9745- | December | 32 Beach |
| | Lewis | Construction | Street, | | 2356-1254 | 2024 | Road, Los |
| | | | Los | | | | Angeles, CA |
| | | | Angeles | | | | 90013 |
| | | | 90013 | | | | |

Step 210 of FIG. 1 may request that a user provide user profile data. Alternatively or additionally step 210 may receive and store user profile data in a profile database after this user profile data has been sent from a user device. Step 210 may be a registration step that is optional as user devices may be allowed to access inventory data at 3^{rd} party vendors even when a prospective customer has not provided user profile information. In other instances, user profile information may be required to view 3^{rd} party inventory data. After step 210, determination step 220 may identify whether a request has been received from a registered user. Methods and apparatus consistent with the present disclosure may identify user devices by attributes unique to a user device, for example, by using a machine identifier or a phone number. Alternatively, users may be required to login or to provide a user identifier. When determination step 220 identifies that a received request to view 3^{rd} party inventory data is not from a registered user, program flow may flow back to step 210 that once again requests user profile information. Alternatively, in instances when an inventory request is not from a registered user, program flow may flow from step 220 to step 230 of FIG. 2. When determination step 220 identifies that an inventory request is received from a registered user, program flow may also flow to step 230. Steps 210 and 220 of FIG. 2 illustrate that access to 3^{rd} party inventory data may, in certain instances, be restricted to users that have provided user profile data. In other instances, any user device may be allowed to access 3^{rd} party inventory data. In yet other instances, both steps 210 and 220 may be optional and any computing device that sends inventory requests to an ordering computing device may be allowed to accesses 3^{rd} party inventory data.

Step 230 of FIG. 2 may access and store relevant 3^{rd} party database data. In an instance, when the inventory request was received from a registered user, that registered user may be provided access to inventory data in step 240 of FIG. 2 that is consistent with their user profile data. Alternatively, a user device of a registered user may be provided inventory data that is limited to specific data that may have been identified in an inventory request. Alternatively, in an instance when the inventory request is received from a user that is not associated with any user profile data (e.g. an unregistered user/user device), this unregistered user/user device may be provided requested inventory data in step 240. After step 240 of FIG. 2, determination step 250 may identify whether an order for products have been received, when no program flow may move back to step 220 of FIG. 2 that was discussed previously. When determination step 250 identifies that an order has been received, program flow may move to step 260, where order information is confirmed. Step 260 may optionally also collect user profile data and store that user profile data in a database, such as profile database 110 of FIG. 1. The order confirmation performed in step 260 of FIG. 2 may require that an authorization from a supervisor device be received before an order is processed. Alternatively or additionally step 260 may receive delivery or other data associated with a customer receiving products that they ordered. After step 260, determination step 270 may identify whether the order was accepted, when the order has not been accepted, program flow may move to step 280, where the order may be cancelled. Determination step 270 may identify that the order has been accepted by a vendor, for example. When the order is accepted, program flow may move from step 270 to step 290, where order fulfillment data may be monitored. The monitoring of the fulfillment data in step 290 may include monitoring the GPS location of a delivery device or may include monitoring whether the customer has picked up the order at a 3^{rd} party vendor. After the order has been fulfilled, program flow may move to step 295 where other program code functions may be performed. These other program code functions may include processing payment information or may include functions associated with other sets of program code at an ordering computer, such as ordering platform device 102 of FIG. 1. These other program code functions performed in step 295 may also include receiving data from a supervisor device that identifies that the order was properly received or may receive data identifying that the order was not properly received. After step 280 of FIG. 2 program flow may move back to step 220 of FIG. 2.

Table 2 illustrates an exemplary set of data that may be collected and that may be stored in an inventory database. The data included in table 2 may be collected by an ordering computer like ordering platform device 102 of FIG. 1 and this data may be stored in the inventory database 112 of FIG. 1. The data stored in table 2 may cross-reference store information with product specifications, product inventory, and pricing information. Note that a first row in table 2 identifies a store name of Lowes, store identifier (ID) L78945, a store address (3 Ocean Blvd, Los Angeles Calif., 90005), product specification (2 inch by 4 inch lumber that are 10 feet long), a product skew of 432480, an available quantity of 1,000 pieces, and a unit price of $5.75. Similarly, table 2 cross-references similar products that are available at vendors Home Depot and Ace Hardware. This information may be reviewed either at a user device or at an ordering computer that reviews order data based on customer requirements. This information may allow a user operating a user device to review information provided by an ordering computer that is independent of any of the vendors illustrated in table 2. Alternatively, the ordering computer may identify a best vendor that can provide inventory that is needed by a customer that best fits received or historical customer requirements.

TABLE 2
Inventory Database Data

| Store | Store | | | Product | Quantity | Unit |
|---|---|---|---|---|---|---|
| Name | ID | Store Address | Product | SKU | Available | Price |
| Lowes | L78945 | 3 Ocean Blvd. | 2″ × 4″ | 432480 | 1,000 | $5.75 |
| | | Los Angeles, | 10′ | | | |
| | | CA, 90005 | Lumber | | | |
| Home | HD6543 | 56 Oak Drive, | 2″ × 4″ | 650123 | 1,200 | $6.25 |
| Depot | | Los Angeles, | 10′ | | | |
| | | CA, 90009 | Lumber | | | |
| Ace | AH1234 | 789 3rd Ave. | 2″ × 4″ | 986456 | 500 | $7.00 |
| Hardware | | Los Angeles, | 10′ | | | |
| | | CA 90009 | Lumber | | | |

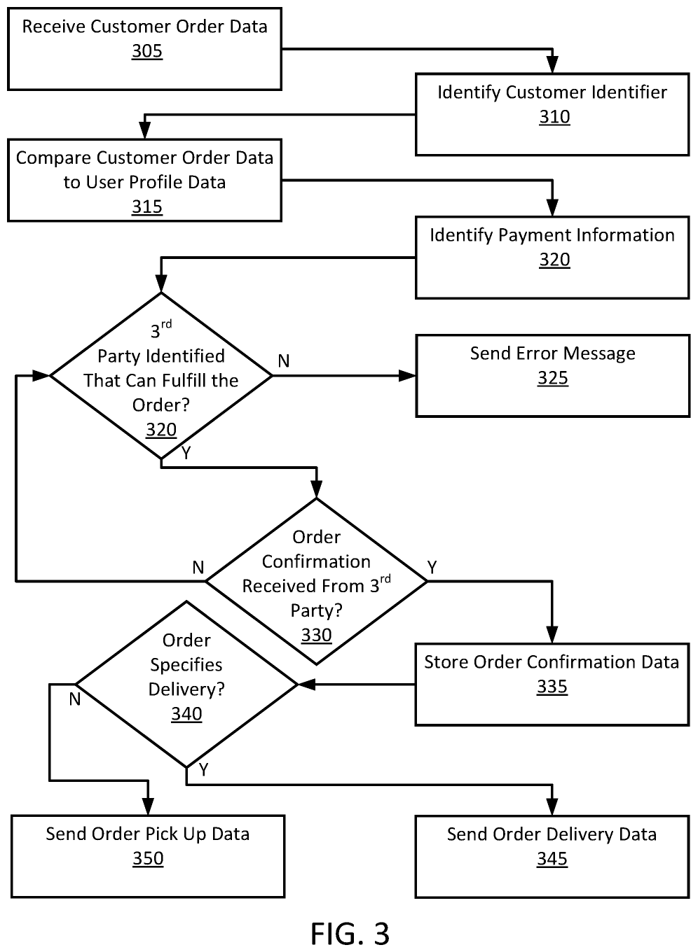

FIG. 3 illustrates a set of steps that may be performed when a customer order is received. The steps of FIG. 3 may be performed by a processor executing instructions from one or more sets of program code. For example, the steps illustrated in FIG. 3 may be associated with an ordering platform software module or with an inventory software module that includes instructions executed by processor 104 of FIG. 1. FIG. 3 begins with step 305 where customer order data is received. While not illustrated in FIG. 3, program flow may move to step 305 only after a supervisor has approved an order for a set of materials. Next, in step 310 of FIG. 3, a customer identifier (ID) may be identified. The customer ID may be identified from information provided by a user via a user device or may be identified using an identifier that uniquely identifies the user device (e.g. a phone number or machine identifier). After the customer ID is identified in step 310, the customer order data received in step 305 may be compared in step 315 with user profile data stored in a user profile database, such as the profile database 110 of FIG. 1. Then, payment information may be extracted from the user profile data in step 320. Next, determination step 320 may identify whether an identified 3^{rd} party vendor can fulfill the order. In certain instances, an identified 3^{rd} party vendor may be a preferred vendor of a customer that is identified in the customer order data or in the user profile data retrieved from a profile database. Alternatively, determination step 320 may identify whether any of a set of 3^{rd} party vendors can fulfill the order. As such, step 320 of FIG. 3 may evaluate whether inventory at any of a set of vendors in a geographical area can fulfill the order and this evaluation may identify a vendor that can fulfill the order within a specified time frame. When one or more 3^{rd} party vendors cannot fulfill the order or cannot fulfill the order within the specified time frame, program flow may move to step 320 where an error message is sent to the user device of the customer.

When determination step 320 identifies a 3^{rd} party vendor that can fulfill the order, program flow may move to determination step 330 of FIG. 3. Determination step 330 may then double check or confirm whether the identified 3^{rd} party vendor can actually fulfill the order. This step may include sending requests to a computer of the 3^{rd} party vendor requesting that vendor to physically check that the ordered products are actually in stock. If for some reason the identified 3^{rd} party vendor cannot conform the order, program flow may move back to determination step 320, previously discussed. In certain instances, program flow may move between step 320 and step 330 as each respective vendor's inventory is checked and confirmed. When determination step 330 identifies that a particular vendor does have stock of the ordered product(s), program flow may move to step 335, where order confirmation may be stored. Next, determination step 340 may identify whether the order specifies delivery. When the order does specify delivery of the ordered product(s), program flow may move to step 345 where order delivery data are sent to a user device of a customer and/or to a delivery device of a delivery service/person. When the order does not specify delivery, program flow may move to step 350 where order pick up data may be sent to a user device of the customer.

Table 3 illustrates an exemplary set of data that may be collected and that may be stored in an delivery database at an ordering device, such as ordering device 102 of FIG. 1. The information in table 3 may allow an ordering device to persistently store product order data that cross-references customer order information. The data stored in table 3 may include a customer ID, a store ID, product order details, product skew information, a quantity of product ordered, an order cost, a transport type (e.g. pickup or delivery), and a confirmation document name. The second row of data in table 3 identifies that customer ID BM0987 submitted an order for a total of 75 square feet of 5′ saddle oak engineered hardwood that was picked up from store HD6543 and delivered to a destination as confirmed by confirmation BM77293.pdf. This second row of table 3 also identifies that the ordered product has a product skew of 773393 and that the ordered product was purchased for a cost of $149.25.

TABLE 3
Order Database Data

| Customer | Store | | Product | | | Transport | |
|---|---|---|---|---|---|---|---|
| ID | ID | Product | SKU | Qty | Cost | Type | Confirmation |
| TJ1234 | L78945 | 2″ × 4″ | 432480 | 25 | $143.75 | Pickup | TJ432480.pdf |
| | | 10′ Lumber | | | | | |
| BM0987 | HD6543 | 5′ Saddle | 772293 | 75 | $149.25 | Delivery | BM77293.pdf |
| | | Oak Eng. | | Sq. | | | |
| | | Hardwood | | Ft. | | | |
| SM6453 | AH1234 | Masonite | 743800 | 4 | $183.92 | Delivery | SM743800.pdf |
| | | Classics | | | | | |
| | | Primed | | | | | |
| | | Hollow | | | | | |
| | | Core with | | | | | |
| | | Molded | | | | | |
| | | Composite | | | | | |
| | | Bi-Fold | | | | | |
| | | Closed | | | | | |
| | | Interior | | | | | |
| | | Door with | | | | | |
| | | Hardware | | | | | |
| | | 24″ x 80″ | | | | | |

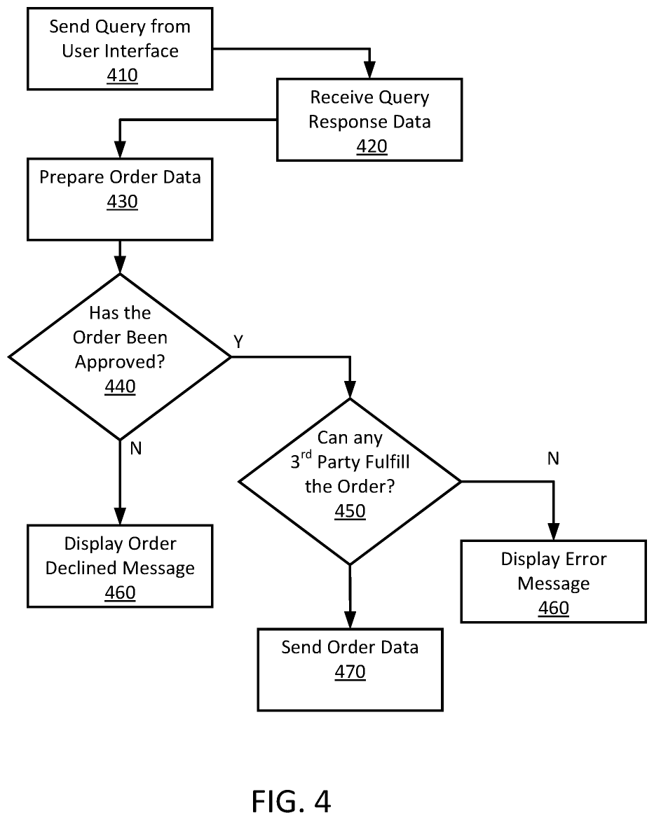

FIG. 4 illustrates a series of steps that may be performed at a user device when a customer orders products. FIG. 4 begins with step 410 where a query is sent from the user device of a customer. This query may be sent to an ordering computer and this query may be or may include a request to check inventory of products at one or more nearby vendors. The steps performed in FIG. 4 may include operations that send and receive information to an ordering computer, such as ordering platform device 102 of FIG. 1. Note also that the steps performed in FIG. 4 may be performed by processor 120 of user device 118 of FIG. 1.

After the request is sent to the ordering computer in step 410, that ordering computer may check inventories listed in a database local to that ordering computer or the ordering computer may send queries to a computers of 3^{rd} party vendors such that the ordering computer may send inventory data back to the user device that match criteria included in the query. Next, in step 420 of FIG. 4, a response to the query may be received. This response may identify inventory that is available at local vendors that match information included in the query. After step 420, order data may be prepared in step 430. After step 430, determination step 440 may confirm whether a supervisor has approved the order, when no (e.g. after an order declined message has been received) program flow may move to step 460 where a message may be provided via a user interface to a user indicating that the order has been declined. In certain instances, a user device may communicate with an ordering device, the ordering device may sent an authorization request to a supervisor device, and the ordering device may forward information that identifies whether the order was accepted or declined by a supervisor to the user device. Alternatively or additionally, the user device may communicate with the supervisor device. For example, order data may be sent from the user device to the supervisor device and then the supervisor device may send an authorization message to the user device. Program code executable by a processor at the user device may include instructions that cause order information at a user device to be locked, such that a user cannot change the order data after a supervisor has approved it.

Next determination step 450 may identify whether any 3^{rd} party vendor can fulfill the order. This determination may be made by a processor that compares the prepared order data to information included in the query response data received in step 420. Alternatively, this determination may be made after the processor compares data in the prepared order to information that identifies materials that a supervisor authorized. When a vendor can fulfill the order, program flow may move to step 470 where the order is sent to the ordering computer. When a vendor cannot fulfill the order, program flow may move to step 460 where an error message may be displayed in a display of the user device.

While the steps of FIG. 4 have been discussed in respect to actions that occur at a user device, similar steps may be performed by both a user device and an ordering computer. For example, a user device could send inventory queries to the ordering computer and the ordering computer may identify a 3^{rd} party vendor based on criteria associated with or provided by the user device. In such instances, query responses could allow the user of a user device to select one or more 3^{rd} party vendors to fulfill an order and that user device could send information to the ordering computer that confirms order details.

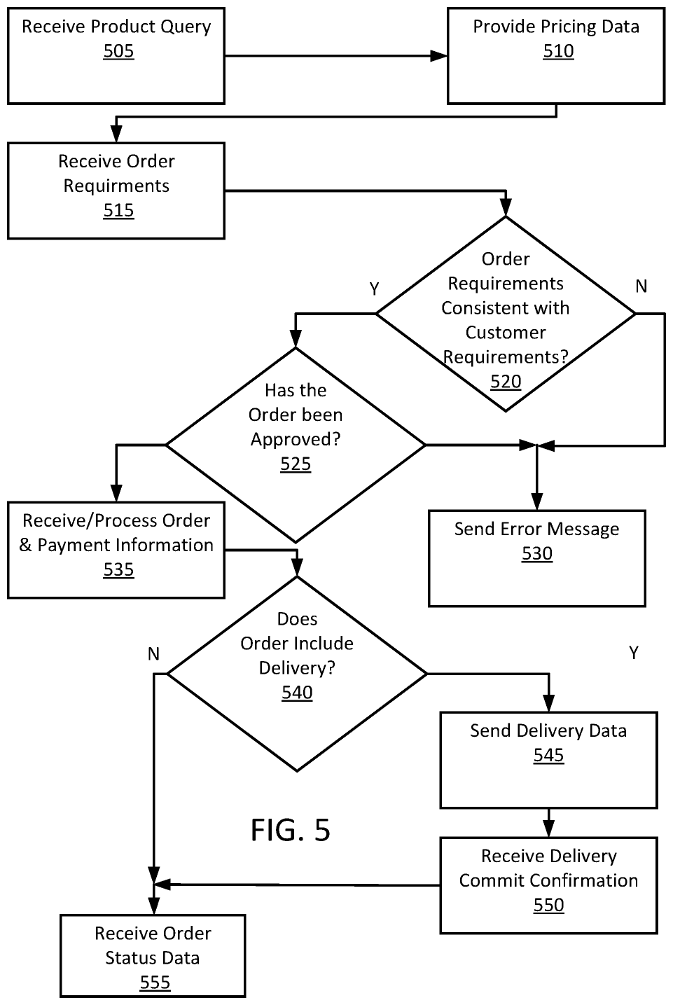

FIG. 5 illustrates another series of steps that may be performed at an ordering computer that receives product queries and that arranges for the fulfillment of product orders. Step 505 of FIG. 5 may receive a product query after which the ordering computer may provide pricing data to a user device in step 510. Next, the ordering computer may receive order requirements from a user device. Then determination step 520 may identify whether the order requirements are consistent with customer requirements stored in a user profile database, when no program flow may move to step 530 where an error message is sent the user device. This error message may result in confirming a set of requirements that should be applied to an order after an order is received.

When determination step 520 identifies that the order requirements are consistent with the customer requirements, program flow may move to determination step 525 that identifies whether the order has been approved. When determination step 525 identifies that the order has not been approved, program flow may move to step 530 where an error message is sent. This error message may indicate that the order was declined by a supervisor. When determination step 525 identifies that the order has been approved, program flow may move to step 535 where an order and payment information for that order are received. Next, determination step 540 may identify whether the order requirements include delivering ordered products to a location, when no program flow may move to step 555. When determination step 540 identifies that the ordered product requirements include delivery, program flow may move to step 545 where delivery data is sent to a delivery device. After step 545 a confirmation may be received from the delivery device in step 550. This confirmation may identify that a delivery person is ready to collect and deliver the ordered products to the delivery location. This confirmation may also identify that the products should be delivered within a required time frame. After step 550, program flow may once again flow to step 555. Step 555 may receive order status information when the order is being delivered or after the order has been fulfilled. When the order requirements include delivery, this status information may identify a time when the delivery is anticipated to be delivered or may include location data that identifies where a delivery truck is currently located. When the order does not include delivery, the order status data received in step 550 may identify that the ordered products have been picked up by an authorized employee of a customer. After the order is delivered, a supervisor may review the delivered materials and may make a selection in a user interface at a supervisor device that causes a delivery confirmation to be sent to an ordering device. After a product is ordered, data in table 3 may be updated and the data in table 3 may be updated again after ordered products are confirmed to have been picked up by a customer or after those products have been delivered to a customer.

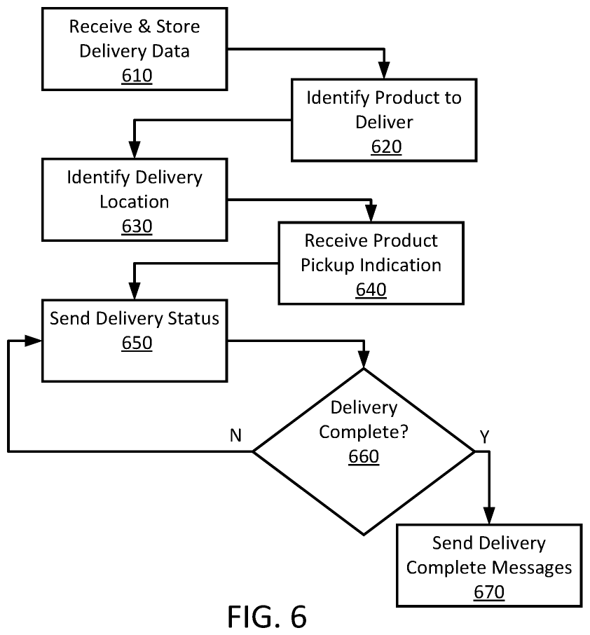

FIG. 6 illustrates a series of steps that may be performed by a device that receives delivery data and that provides delivery status information to other computing devices. FIG. 6 begins with step 610, where delivery data is received and stored in a memory or database at a delivery device, such as delivery device 136 of FIG. 1. As such, step 610 may receive the delivery data via communication interface 142 at delivery device 136 and that delivery data may be stored in database 144 or 146 at delivery device 136. A person operating delivery device 136 may review client data and delivery data via a display that displays delivery GUI 148.

After delivery data is received at step 610, that delivery data may be parsed to identify one or more products to deliver at step 620 and a delivery location may be identified at step 630. Next in step 640 of FIG. 6, an indication may be received at the delivery device that identifies that the ordered product or products have been picked up by the delivery person. This indication may be received via a GUI at the delivery device or may be identified based scanning identifier associated with the ordered products. After the ordered product or products are picked up by the delivery person, the delivery device may send delivery status information to other computing devices (e.g. the ordering computer, the user device of a customer, or a computer of a 3^{rd} party vendor) in step 650 of FIG. 6. This delivery information may include an estimated time or arrival or may include a location of the delivery truck. After step 650, determination step 660 may identify whether the delivery has been completed. When the delivery has not been completed, program flow may move back to step 650 of FIG. 6. When determination step 660 identifies that the delivery is complete, program flow may move to step 660 where delivery complete messages may be sent to other computing devices. For example, these delivery complete messages may be sent to the ordering computer, the user device of a customer, or the computer of a 3^{rd} party vendor. A delivery may be identified as being completed based on a signature of a receiving person, a GPS location that coincides with the delivery location, short distance wireless communications exchanged between the user device that sent the order and the delivery device, or combination thereof. In such instances, these short distance communications may be sent using communications consistent with a Bluetooth communication standard or communications consistent with a near field radio communication. Information used to confirm a delivery may also include photographs of the products that were delivered.

To facilitate the accurate delivery of ordered products, a delivery device may receive information and store that information in a delivery database. The information stored in the delivery database may include some or all of the information included in the user profile database of table 1 and in the order database of table 2. As such, a delivery device database may store product pickup information that identifies store names, sore identifiers, store locations (e.g. address or GPS location), product skew number, product quantities associated with an order, and a total cost for particular orders. A delivery device database may also store client information that may include a customer identifier, a jobsite location (e.g. address or GPS location), payment information, and confirmation documentation (e.g. a purchase order that may be in Adobe Acrobat pdf format). Information related to a set of deliveries may be stored such that a single truck may fulfill orders made by different customers. In such instances products may need to be picked up at different vendor locations and may need to be delivered to different locations by a single truck. As such, methods and apparatus consistent with the present disclosure may allow a delivery person to pickup and deliver ordered products with a minimal amount of driving. For example, a delivery truck may pick up and deliver products in a loop according to driving directions that allow products from different vendors to by picked up and delivered to different worksites, without a driver having to retrace a portion of a same path.

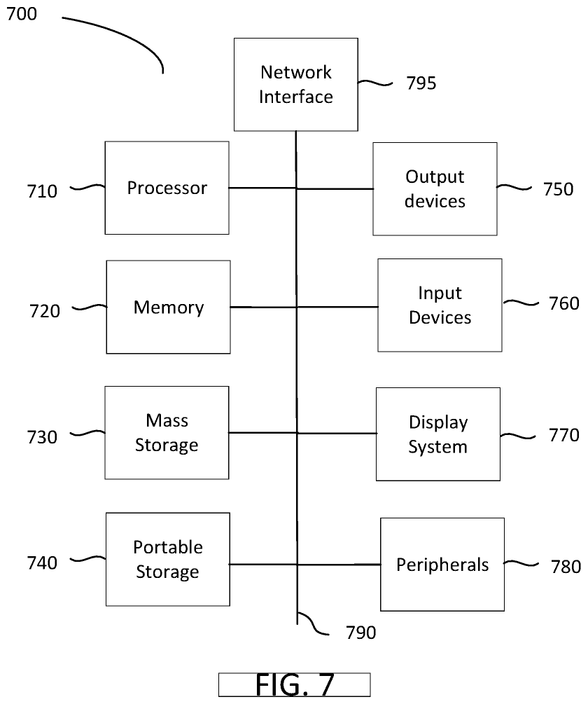

FIG. 7 illustrates a computing system that may be used to implement an embodiment of the present invention. The computing system 700 of FIG. 7 includes one or more processors 710 and main memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, peripheral devices 780, and network interface 795.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a FLASH memory, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD), a plasma display, an organic light-emitting diode (OLED) display, an electronic ink display, a projector-based display, a holographic display, or another suitable display device. Display system 770 receives textual and graphical information, and processes the information for output to the display device. The display system 770 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 780 may include any type of computer support device to add additional functionality to the computer system. For example, peripheral device(s) 780 may include a modem or a router.

Network interface 795 may include any form of computer interface of a computer, whether that be a wired network or a wireless interface. As such, network interface 795 may be an Ethernet network interface, a BlueTooth™ wireless interface, an 802.11 interface, or a cellular phone interface.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

What is claimed is:

1. A method for ordering products, the method comprising:
receiving registration information that identifies a first business name, payment information, a first worksite location, and a supervisor device;
extracting order information that identifies a first product from a received order;
identifying that the order for the first product is associated with the registration information that identifies the first business name, the payment information, the first worksite location, and the supervisor device;
sending an order validation request message to the supervisor device; and
receiving a response to the validation request message that identifies that the order for the first product has been authorized, wherein the order for the first product is fulfilled after the order for the first product has been authorized.

2. The method of claim 1, further comprising:
receiving a request to review inventory data for the first product that is available for purchase at a store within a distance from the first worksite location based on the store being located within the distance from the first worksite location, wherein the request is received from a user device;
sending the first product inventory data to the user device based on the user device being associated with the first business name included in the received registration information; and
sending information regarding the order to a delivery device, wherein the first product is picked up at the store and delivered to the first worksite location based on the order information being sent to the delivery device, and first product is paid for according to the payment information.

3. The method of claim 2, further comprising identifying that the order should be delivered to the first worksite location within a time frame associated with the order, wherein the first product is picked up at the store and delivered to the first worksite location within the time frame associated with the order.

4. The method of claim 1, further comprising receiving a confirmation message from the supervisor device that indicates that the first product has been received.

5. The method of claim 2, further comprising storing the registration information, wherein the registration information is associated with a customer identifier.

6. The method of claim 5, wherein received request includes the customer identifier.

7. The method of claim 5, wherein the registration information includes information that identifies the user device and the method further comprising:
identifying that the order was received from the user device based on information received from the user device; and
identifying that the registration information that identifies the user device matches the user device identifying information received from the user device.

8. The method of claim 3, further comprising:
receiving a second order for a second product that should be delivered to a second worksite location;
identifying that the second order is received from a second user device that is associated with additional registration information that includes a second business name; and
sending information identifying a second store, the second product, and the second worksite location to the delivery device, wherein the second product is picked up at the second store and delivered to the second worksite location based on the receipt of the second order and according to the additional registration information.

9. The method of claim 8, further comprising sending routing information to the destination device, the routing information identifying a path that a driver of a delivery vehicle can proceed for picking up the first product at the store, for picking up the second product at the second store, for dropping off the first product at the first worksite location, and for dropping off the second product at the second worksite location without traversing a portion of the path a second time.

10. The method of claim 1, further comprising:
sending inventory requests to one or more vendor computers that identifies the first product;
receiving the first product inventory data from the one or more vendor computers; and
identifying that a first vendor of one or more vendors can fulfill the order.

11. The method of claim 10, further comprising identifying that the first vendor is preferred over a second vendor of the one more vendors based on at least one of customer preference information or information received from the supervisor device.

12. The method of claim 1, further comprising:
receiving an order for a second product;
identifying that the second product should be prepared for pickup at a first vendor of one or more vendors; and
sending the order for the second product to the first vendor, wherein the second product is picked up at the first vendor after the order for the second product is received.

13. A non-transitory computer readable storage medium having embodied thereon a program executable by a processor for implementing a method for ordering products, the method comprising:
receiving registration information that identifies a first business name, payment information, a first worksite location, and a supervisor device;
extracting order information from a received order that identifies a first product;
identifying that the order for the first product is associated with the registration information that identifies the first business name, the payment information, the first worksite location, and the supervisor device;
sending an order validation request message to the supervisor device; and
receiving a response to the validation request message that identifies that the order for the first product has been authorized, wherein the order for the first product is fulfilled after the order for the first product has been authorized.

14. The non-transitory computer readable storage medium of claim 13, the program further executable to:
receiving registration information that identifies a first business name, payment information, a first worksite location, and a supervisor device;
extracting order information that identifies a first product from a received order;
identifying that the order for the first product is associated with the registration information that identifies the first business name, the payment information, the first worksite location, and the supervisor device;
sending an order validation request message to the supervisor device; and
receiving a response to the validation request message that identifies that the order for the first product has been authorized, wherein the order for the first product is fulfilled after the order for the first product has been authorized.

15. The non-transitory computer readable storage medium of claim 14, the program further executable to identify that the order should be delivered to the first worksite location within a time frame associated with the order, wherein the first product is picked up at the store and delivered to the first worksite location within the time frame associated with the order.

16. The non-transitory computer readable storage medium of claim 13, the program further executable to receive a confirmation message from the supervisor device that indicates that the first product has been received.

17. The non-transitory computer readable storage medium of claim 14, the program further executable to store the registration information, wherein the registration information is associated with a customer identifier.

18. The non-transitory computer readable storage medium of claim 17, wherein received request includes the customer identifier.

20. An apparatus for ordering products, the apparatus comprising:
a memory;
a processor that executes instructions out of the memory to:
store received registration information that identifies a first business name, payment information, a first worksite location, and a supervisor device,
extract order information that identifies a first product from a received order, identify that the order for the first product is associated with the registration information that identifies the first business name, the payment information, the first worksite location, and the supervisor device, and
prepare an order validation request message to be sent to the supervisor device, wherein the validation request message is sent to the supervisor device; and
a communication interface that receives a response to the validation request message, the response including information that identifies that the order for the first product has been authorized, wherein the order for the first product is fulfilled after the order for the first product has been authorized.
